(19) United States
(12) Patent Application Publication
(10) Pub. No.: US 2007/0151405 A1
(43) Pub. Date: Jul. 5, 2007

(54) Thermostat-containing heated steering wheel assembly

(76) Inventors: Richard Matsu, Plymouth, MI (US); Mark Ressler, Waterford, MI (US); Pontus Soderstrom, Rochester, MI (US)

Correspondence Address: Sally J. Brown;Autoliv ASP, Inc., 3350 Airport Road, Ogden, UT, 84405, US

(21) Appl. No.: 11/300,713

(22) Filed: Dec. 15, 2005

(51) Int. Cl. B62D 1/04; G05G 1/10

(52) U.S. Cl. 74/552

(57) ABSTRACT

A thermostat-containing assembly for use in a heated steering wheel assembly. The thermostat-containing assembly includes a retainer device having a shaped body including a thermostat retention aperture and at least one wiring retention channel. The body is shaped to conform to a retainer-accepting region in the peripheral portion of the steering wheel. A thermostat is disposed within the thermostat retention aperture and includes a thermostatically sensitive portion in thermal contact with a heating element. Electrical wiring is disposed within the wiring retention channel and operationally joins the thermostat with an electric power source and the heating element.

### BACKGROUND OF THE INVENTION

This invention relates generally to steering wheels for motor vehicles and, more particularly, to heated steering wheels such as heated steering wheel assemblies that contain one or more thermostats or other regulators that need be in contact with an associated heating element.

Under common cold ambient conditions, a steering wheel for a motor vehicle can become sufficiently cold so as to cause or result in discomfort to a driver, particularly in those instances where the driver is seeking to steer the vehicle without the benefit of gloves or other desired hand covering. Alternatively, a driver wearing gloves designed to provide protection against the cold may experience an undesired reduction in manual dexterity and, subsequently, an undesired reduction in vehicle control. Thus, the inclusion of a heated steering wheel can desirably increase or improve the comfort of a driver as well as facilitate vehicle steering and operation. Moreover, the inclusion of a heated steering wheel can serve as a desirable point of product differentiation as compared to otherwise similarly equipped automobiles. For these and other reasons apparent to those skilled in the art, heated steering wheels are a vehicle feature that has experienced significant and rapid growth in popularity.

Various means are available for the control of heating temperature. One typically cost effective technique for the control of heating temperature is through the incorporation and use of a thermostat. Unfortunately, the inclusion of components, such as thermostats, to effect desired control of associated heating elements can present various design challenges, particularly in motor vehicle applications. For example, for reasons of aesthetics it may be desired to minimize the visual impression of the presence of steering wheel heating features. In particular, it may be desired to incorporate control features, such as a thermostat, and associated wiring and interconnections in such a way that they normally can remain undetected, visually and/or tactually, by an ultimate user. To this end, it is common for a heated steering wheel assembly to have components such as a thermostat, associated wiring and interconnections covered or disposed below a selected steering wheel cover element. In addition, appearance or otherwise cosmetic concerns such as read through (e.g., where shapes or features disposed below such a cover element can be relatively easily discerned from a viewing of the front side of the cover element) are sought to be avoided.

Thus, there has been a need and a demand for heated steering wheel assemblies wherein component parts such as thermostats, wiring and associated interconnections can be more simply and effectively mounted and in such a way that they can effectively avoid detection, either visually or tactually, by the final user, e.g., the vehicle driver.

### SUMMARY OF THE INVENTION

A general object of the invention is to provide an improved heated steering wheel assembly.

A more specific objective of the invention is to overcome one or more of the problems described above.

The general object of the invention can be attained, at least in part, through a thermostat-containing assembly for use in a heated steering wheel assembly. In general, such a heated steering wheel assembly includes a vehicular steering wheel having a hub portion and a peripheral portion including a rim and at least one spoke joining the hub with the rim. The heated steering wheel assembly also includes a heating element disposed about the rim in heat transfer communication therewith. The thermostat-containing assembly includes a retainer device having a shaped body including a first thermostat retention aperture and at least one wiring retention channel. The body of the retainer device is desirably shaped to conform to a retainer-accepting region in the peripheral portion of the steering wheel. The thermostat-containing assembly also includes a first thermostat disposed within the first thermostat retention aperture. The first thermostat has or includes a thermostatically sensitive portion in thermal contact with the heating element. The thermostat-containing assembly further includes electrical wiring disposed within the wiring retention channel and operationally joining the first thermostat with an electric power source and the heating element.

The prior art generally fails to provide heat steering wheel assemblies wherein component parts such as thermostats, wiring and associated interconnections can be mounted as simply and effectively as may be desired and in such a way that they can effectively avoid detection, either visually or tactually, by the final user, e.g., the vehicle driver.

The invention further comprehends a thermostat-containing assembly for use in a heated steering wheel assembly. The heated steering wheel assembly includes a vehicular steering wheel having a hub portion and a peripheral portion that includes a rim and at least one spoke joining the hub with the rim. The steering wheel has a driver-facing side and an opposed vehicle-facing side. The heated steering wheel assembly further includes a heating element disposed about the rim in heat transfer communication therewith and a steering wheel cover element disposed about the rim in covering relationship with the heating element. In accordance with one preferred embodiment, the thermostat-containing assembly includes a retainer device having a shaped body including first and second thermostat retention apertures and at least one wiring retention channel. The retainer device body is desirably shaped to conform to a retainer-accepting region in the peripheral portion on the vehicle-facing side of the steering wheel. The thermostat-containing assembly further includes a first thermostat disposed within the first thermostat retention aperture and a second thermostat disposed within the second thermostat retention aperture. Each of the first and second thermostats includes a thermostatically sensitive portion in thermal contact with the heating element. The thermostat-containing assembly further includes electrical wiring disposed within the wiring retention channel and operationally joining each of the first and second thermostats with an electric power source and the heating element.

Other objects and advantages will be apparent to those skilled in the art from the following detailed description taken in conjunction with the appended claims and drawings.

### BRIEF DESCRIPTION OF THE DRAWINGS

FIG. 1 is a simplified plan view of a heated vehicle steering wheel assembly in accordance with one embodiment of the invention.

FIG. 2 is a simplified plan view of a thermostat-containing assembly in accordance with one embodiment of the invention, showing a fragmentary portion of an associated heating element carrier.

FIG. 3 is a simplified plan view of a thermostat retainer device in accordance with one embodiment.

FIG. 4 is a simplified view of the thermostat retainer device shown in FIG. 3 in combination with associated thermostat devices, disposed onto a steering wheel in accordance with one embodiment.

FIG. 5 is a fragmentary side view of the thermostat retainer device shown in FIG. 3 in combination with an associated thermostat device.

FIG. 6 is a simplified plan view of a thermostat retainer device in accordance with another embodiment.

FIG. 7 is a simplified cross sectional view of the thermostat retainer device shown in FIG. 6 and viewed substantially along the line 7-7 in FIG. 6.

FIG. 8 is a simplified cross sectional view of the thermostat retainer device shown in FIG. 6 viewed substantially along the line 8-8 in FIG. 6 in combination with thermostats disposed therewith.

FIG. 9 is a simplified electrical schematic of a heat steering wheel assembly in accordance with one embodiment.

### DETAILED DESCRIPTION OF THE INVENTION

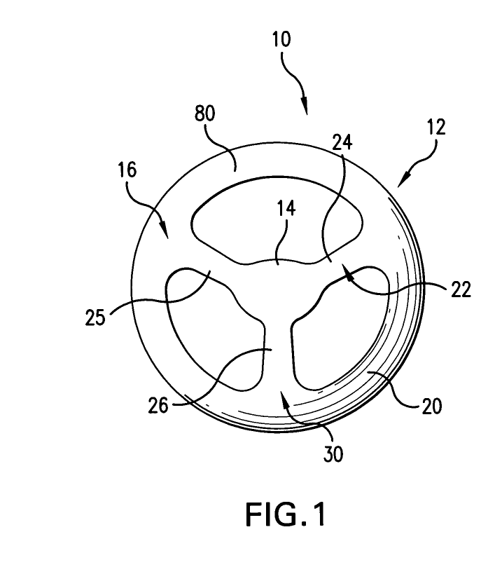

The present invention provides a thermostat-containing assembly for use in a heated steering wheel assembly. As will be appreciated, the present invention may be embodied in a variety of different structures. As representative, FIG. 1 illustrates the present invention as embodied in a heated vehicle steering wheel assembly, generally designated by the reference numeral 10, in accordance with one embodiment of the invention.

The heated steering wheel assembly 10 includes a vehicular steering wheel 12 having a hub portion 14 and a peripheral portion 16 including a rim 20 and spokes 22, individually designated as spokes 24, 25, and 26, respectively, joining the hub 14 with the rim 20. While the heated steering wheel assembly 10 has been shown as including three spokes 22, those skilled in the art and guided by the teachings herein provided will appreciate that steering wheel assemblies in accordance with the invention will desirably include at least one and most commonly at least two spokes 22, the broader practice of the invention is not necessarily limited by the number of spokes included in the steering wheel. The steering wheel 12 has a driver-facing side, generally designated by the reference numeral 30 and an opposed vehicle-facing side, generally designated by the reference numeral 32 and shown in FIG. 4, described below.

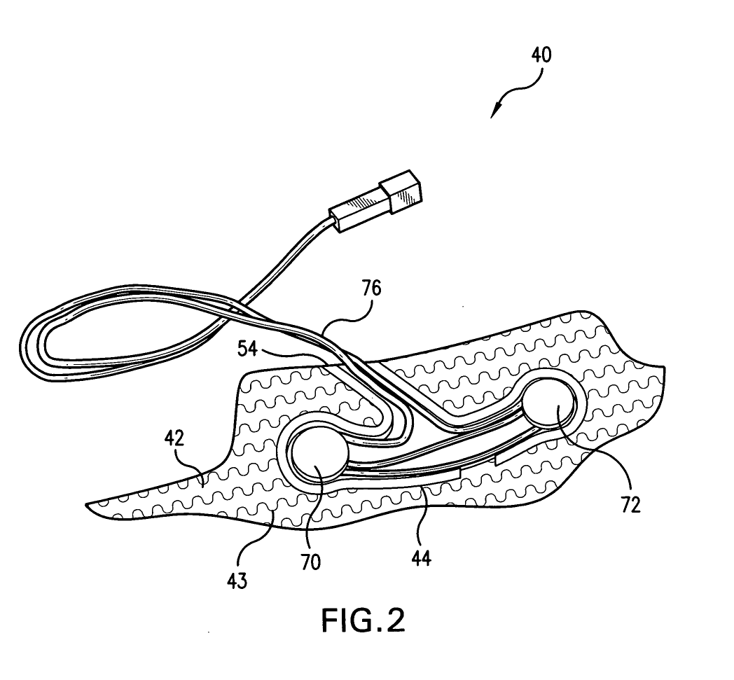

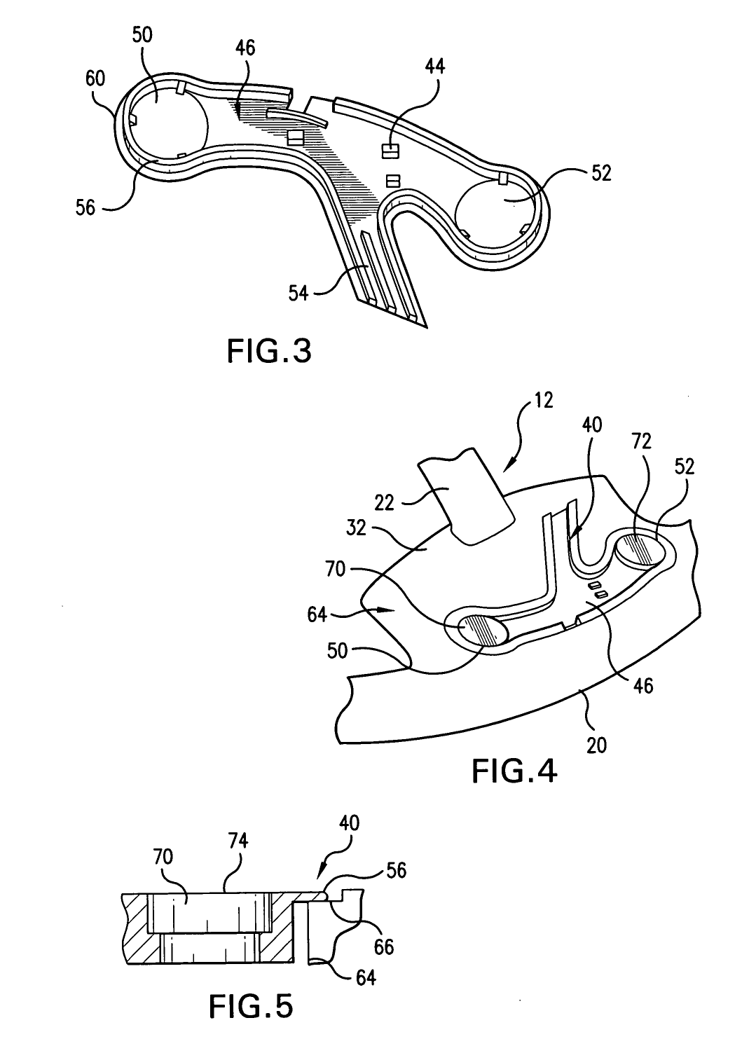

A thermostat-containing assembly, generally designated by the reference numeral 40, in combination with a heating element carrier 42 and including a heating element 43 such as in the form of a resistance heating wire, such as for placement onto the steering wheel 12, is shown laid out in plan view isolation in FIG. 2. As shown in FIG. 2, the heating element 43 can desirably be composed of a resistance heating wire and the heating element carrier 42 can be composed of a fabric mat. The thermostat-containing assembly 40 comprises a retainer device 44, shown in isolation in FIG. 3.

The retainer device 44 has a shaped body portion 46 including a first thermostat retention aperture 50, a second thermostat retention aperture 52 and one or more wiring retention channels 54. The retainer device 44, in accordance with one preferred embodiment, includes a peripheral flange 56 such as disposed at peripheral surface edge 60 thereof.

FIG. 4 in turn shows the thermostat-containing assembly 40 disposed at a preferred retainer-accepting region 64, such as on the vehicle-facing side 32 of the steering wheel 12, such as located at a junction of the rim 20 and at least one spoke 22, as shown in FIG. 1. In particular, as shown in FIG. 4, the retainer device body portion 46 is shaped to conform to such retainer-accepting region 64 in the peripheral portion of the associated steering wheel. In accordance with a preferred embodiment, the retainer device 44 is desirably designed and shaped such as to match or appropriately mate with the surface geometry of the steering wheel at the corresponding or associated placement location therefore. As a result, the possibility of read through and various fit and finish issues can be desirably minimized or preferably avoided.

Turning to FIG. 5, there is shown a fragmentary portion of the thermostat-containing assembly 40 disposed onto the retainer-accepting region 64 in the peripheral portion of the associated steering wheel. As shown, the steering wheel and, in particular, the retainer-accepting region 64 thereof, may desirably incorporate or include one or more mating features such as here shown in the form of ledge 66, such as adapted for engagement contact with the peripheral flange 56 of the retainer device 44.

As shown in FIG. 3, the peripheral flange 56 desirably extends about the outer circumference of the retainer device 44. It is to be understood, however, that the broader practice of the invention is not necessarily limited to retainer devices that include such a peripheral flange about the entire outer circumference thereof or even a portion thereof. For example, if desired, a retainer device in accordance with the invention may include such a peripheral flange only about a selected peripheral portion, alternatively, the invention may be practiced with a retainer device free of such a peripheral flange.

As shown in FIG. 4, a first thermostat 70 is disposed within the first thermostat retention aperture 50 and a second thermostat 72 is disposed within the second thermostat retention aperture 52. Those skilled in the art and guided by the teachings herein provided will appreciate that the thermostats desirably include a thermostatically sensitive portion, designated by the reference numeral 74, relative to the thermostat 70 shown in FIG. 5. Similarly, the second thermostat 72 desirably also includes a thermostatically sensitive portion.

As shown in FIG. 2, such thermostatically sensitive portions are desirably in thermal contact with the heating element carrier 42, more particularly, the heating element 43. Also, the electrical wiring 76 is desirably disposed within the one or more wiring retention channels 54. The electrical wiring 76 desirably operationally joins each of the first and second thermostats 70 and 72 with an electric power source (not shown) and the heating element 43.

Those skilled in the art and guided by the teachings herein provided will appreciate that such thermostat-containing assemblies, in accordance with the invention, desirably can be formed as a subassembly prior to attachment to or with a heating element and subsequent installation in or to a vehicle steering wheel. As a result, such a subassembly can desirably significantly simplify and reduce the cost normally associated with the vehicular installation of a heated steering wheel.

In the heated steering wheel assembly 10, the heating element carrier 42 is disposed about the rim 20 (shown in FIG. 1) in heat transfer communication therewith and a steering wheel cover element 80 (also shown in FIG. 1) is disposed about the rim 20 in covering relationship with the heating element carrier 42.

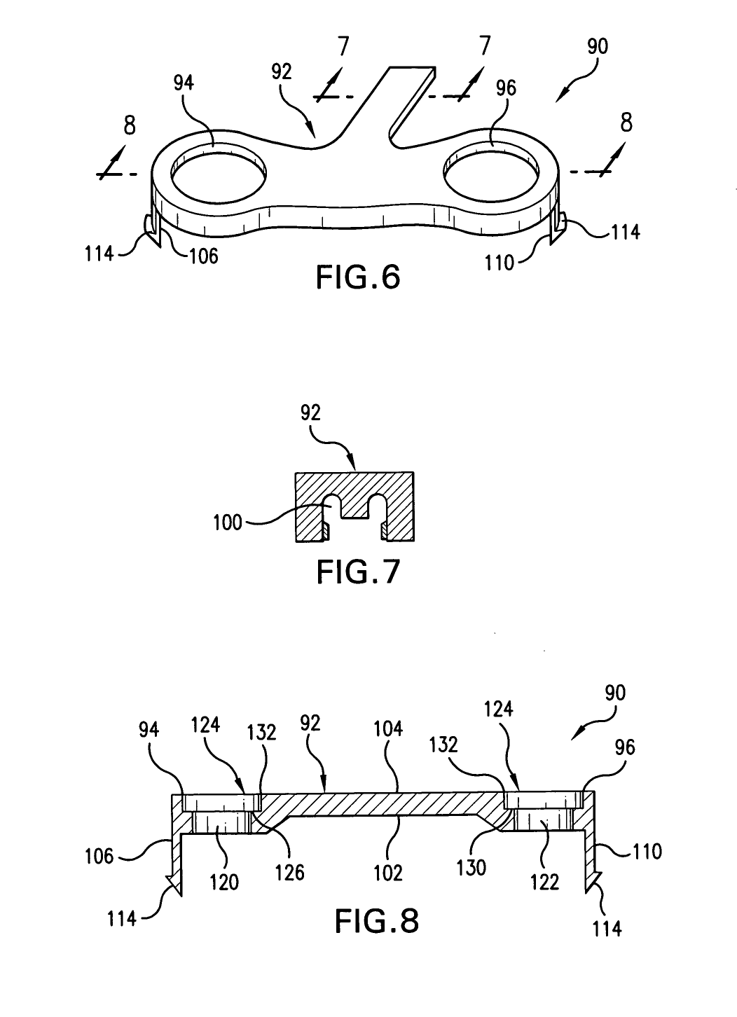

FIGS. 6-8 illustrate a retainer device 90 in accordance with another embodiment of the invention. The retainer device 90, similar to the retainer device 44 described above, has a shaped body portion 92 such as includes a first thermostat retention aperture 94, a second thermostat retention aperture 96 and one or more wiring retention channels 100 (as perhaps best viewed in FIG. 7).

The retainer device shaped body 92 includes a steering wheel substrate adjacent surface 102 and an opposed steering wheel cover adjacent surface 104. The retainer device shaped body 92 additionally includes at least one and, in the illustrated embodiment two, retention arms 106 and 110, respectively, extending from the steering wheel substrate adjacent surface 102. The retention arms 106 and 110 are desirably adapted to join the retainer device 90 with an associated steering wheel via a snap-lock connection. For example, as shown, the retention arms 106 and 110 may desirably incorporate, include or have barbs or the like, designated by the reference numeral 114. Such barbs in turn are adapted to engage with openings or cavities provided in an associated steering wheel rim, or spoke material such as to further secure the retainer to the steering wheel and assist in minimizing or avoiding bridging of the associated steering wheel cover element, particularly in the case of a leather steering wheel cover element.

FIG. 8 illustrates the retainer device 90 in combination with a first thermostat 120 disposed within the first thermostat retention aperture 94 and a second thermostat 122 is disposed within the second thermostat retention aperture 96. The thermostats 120 and 122, as is common in the art, each include a head portion 124 of increased diameter. Each of the thermostat retention apertures 94 and 96 in turn includes a shoulder 126 and 130 such as upon which a circumference section 132 of each of the head portions 124 the respective thermostats 120 and 122, respectively, rests. The thermostats 120 and 122 are firmly fixed in or with the retainer 90 such that direct contact with an associated heating element can be realized without the inclusion or use of a thermal barrier, such as in the form of glue, at or on the thermostatically sensitive portion of the thermostat and such as may otherwise impact the thermal sensitivity or performance thereof. For example, glue, if desired to be used, can be applied onto the steering wheel cover adjacent surface 104 of the shaped body portion 92 of the retainer device 90, such to result in or provide desired joining of an associated cover element about the thermostat-containing heated steering wheel assembly of the invention, without detrimentally impacting the performance of associated thermostats.

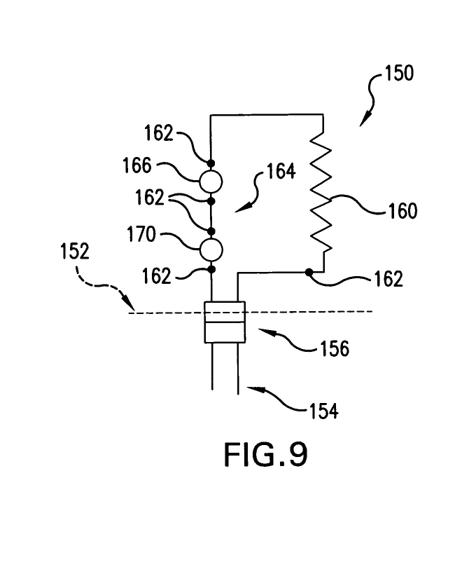

FIG. 9 is a simplified electrical schematic of a heated steering wheel assembly, generally designated by the reference numeral 150, as disposed within a vehicle in accordance with one embodiment. The dashed line 152 denotes a demarcation between the heated steering wheel assembly 150 and the balance of the vehicle 154. A main interconnect 156 occurs between the heated steering wheel assembly 150 and the balance of the vehicle 154. The heated steering wheel assembly 150 includes a heating element 160 interconnected via the interconnects 162 with a thermostat-containing assembly 164, in accordance with the invention, and such as includes thermostats 166 and 170.

While the invention has been described above making specific reference to embodiments incorporating two thermostats, those skilled in the art and guided by the teachings herein will appreciate that, if desired, the invention can be practiced with embodiments incorporating a single thermostat. Alternatively, if desired, the invention may also be practiced with embodiments employing three or more thermostats.

From the above it will be appreciated that the invention provides heat steering wheel assemblies wherein component parts such as thermostats, wiring and associated interconnections can be mounted in a simple and effective manner and in such a way that they can effectively avoid detection, either visually or tactually, by the final user, e.g., the vehicle driver. In particular, the thermostats, wiring and associated interconnections are mounted or disposed in a specifically designed retainer device having a shaped body including a thermostat retention aperture and a wiring retention channel and the body is shaped to conform to a retainer-accepting region in a peripheral portion of an associated steering wheel.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A thermostat-containing assembly for use in a heated steering wheel assembly, the heated steering wheel assembly including a vehicular steering wheel having a hub portion and a peripheral portion including a rim and at least one spoke joining the hub with the rim, the heated steering wheel assembly also including a heating element disposed about the rim in heat transfer communication therewith, the thermostat-containing assembly comprising:
a retainer device having a shaped body including a first thermostat retention aperture and at least one wiring retention channel, the body shaped to conform to a retainer-accepting region in the peripheral portion of the steering wheel;
a first thermostat disposed within the first thermostat retention aperture, the first thermostat including a thermostatically sensitive portion in thermal contact with the heating element; and
electrical wiring disposed within the wiring retention channel and operationally joining the first thermostat with an electric power source and the heating element.

2. The thermostat-containing assembly of claim 1 wherein the steering wheel includes a driver-facing side and an opposed vehicle-facing side, wherein the retainer device shaped body conforms to a retainer-accepting region located on the vehicle-facing side of the steering wheel.

3. The thermostat-containing assembly of claim 2 wherein the retainer-accepting region is located at a junction of the rim and the at least one spoke.

4. The thermostat-containing assembly of claim 1 wherein the first thermostat includes a head portion of increased diameter and the first thermostat retention aperture includes a shoulder upon which the head portion of the first thermostat rests.

5. The thermostat-containing assembly of claim 1 wherein the retainer device shaped body has peripheral flange, and wherein the peripheral flange and a mating feature in the retainer-accepting region in the peripheral portion of the steering wheel are in engagement contact.

6. The thermostat-containing assembly of claim 1 wherein the retainer device shaped body includes a steering wheel substrate adjacent surface and an opposed steering wheel cover adjacent surface, wherein the retainer device shaped body additionally comprises at least a first retention arm extending from the steering wheel substrate adjacent surface, the retention arm adapted to join the retainer device with the steering wheel via a snap-lock connection.

7. The thermostat-containing assembly of claim 1 wherein the thermostatically sensitive portion of the first thermostat is in direct contact with the heating element.

8. The thermostat-containing assembly of claim 1 wherein:
the retainer device shaped body additionally includes a second thermostat retention aperture and
wherein the thermostat-containing assembly additionally comprises:
a second thermostat disposed within the second thermostat retention aperture, the second thermostat including a thermostatically sensitive portion in thermal contact with the heating element; and
electrical wiring disposed within the wiring retention channel and operationally joining the second thermostat with the electric power source and the heating element.

9. The thermostat-containing assembly of claim 1 additionally comprising a steering wheel cover element disposed about the rim in covering relationship with the heating element.

10. The thermostat-containing assembly of claim 9 wherein steering wheel cover element comprises leather.

11. A thermostat-containing assembly for use in a heated steering wheel assembly, the heated steering wheel assembly including a vehicular steering wheel having a hub portion and a peripheral portion including a rim and at least one spoke joining the hub with the rim, the steering wheel also having a driver-facing side and an opposed vehicle-facing side, the heated steering wheel assembly including a heating element disposed about the rim in heat transfer communication therewith and a steering wheel cover element disposed about the rim in covering relationship with the heating element, the thermostat-containing assembly comprising:
a retainer device having a shaped body including first and second thermostat retention apertures and at least one wiring retention channel, the body shaped to conform to a retainer-accepting region in the peripheral portion on the vehicle-facing side of the steering wheel;
a first thermostat disposed within the first thermostat retention aperture, the first thermostat including a thermostatically sensitive portion in thermal contact with the heating element;
a second thermostat disposed within the second thermostat retention aperture, the second thermostat including a thermostatically sensitive portion in thermal contact with the heating element; and
electrical wiring disposed within the wiring retention channel and operationally joining each of the first and second thermostats with an electric power source and the heating element.

12. The thermostat-containing assembly of claim 11 wherein the retainer-accepting region is located at a junction of the rim and the at least one spoke.

13. The thermostat-containing assembly of claim 11 wherein the first thermostat includes a head portion of increased diameter and the first thermostat retention aperture includes a shoulder upon which the head portion of the first thermostat rests.

14. The thermostat-containing assembly of claim 13 wherein the second thermostat includes a head portion of increased diameter and the second thermostat retention aperture includes a shoulder upon which the head portion of the second thermostat rests.

15. The thermostat-containing assembly of claim 11 wherein the retainer device shaped body has peripheral flange, and wherein the peripheral flange and a mating feature in the retainer-accepting region in the peripheral portion of the steering wheel are in engagement contact.

16. The thermostat-containing assembly of claim 11 wherein the retainer device shaped body includes a steering wheel substrate adjacent surface and an opposed steering wheel cover adjacent surface, wherein the retainer device shaped body additionally comprises at least a first retention arm extending from the steering wheel substrate adjacent surface, the retention arm adapted to join the retainer device with the steering wheel via a snap-lock connection.

17. The thermostat-containing assembly of claim 11 wherein the thermostatically sensitive portion of the first thermostat is in direct contact with the heating element.

18. The thermostat-containing assembly of claim 17 wherein the thermostatically sensitive portion of the second thermostat is in direct contact with the heating element.

19. The thermostat-containing assembly of claim 11 wherein steering wheel cover element comprises leather.
